(19) United States
(12) Patent Application Publication
(10) Pub. No.: US 2025/0348098 A1
(43) Pub. Date: Nov. 13, 2025

(54) LOW DROP-OUT REGULATOR WITH ACTIVE DISCHARGE CIRCUIT

(71) Applicant: SAMSUNG ELECTRONICS CO., LTD., SUWON-SI (KR)

(72) Inventors: Subba reddy Siddamurthy, BANGALORE (IN); Aswani Aditya kumar Tadinada, BANGALORE (IN); Venkatasuryam setty Issa, BANGALORE (IN)

(21) Appl. No.: 18/801,983

(22) Filed: Aug. 13, 2024

(30) Foreign Application Priority Data
May 9, 2024 (IN) 202441036797

(51) Int. Cl. G05F 1/575

(52) U.S. Cl. CPC G05F 1/575

(57) ABSTRACT

An LDO regulator circuit includes an Active Capacitor Frequency Compensation (ACFC) circuit and an output circuit. The ACFC circuit includes a current amplifier. The output circuit includes a pass transistor, an output node and an active discharge circuit connected to the output node. The current amplifier includes a source degeneration resistor-capacitor (RC) configured to control a gain of the current amplifier. The ACFC circuit is configured to control a voltage across a gate source junction of the pass transistor. The active discharge circuit is configured to drain a current from the output node based on a voltage across the gate source junction of the pass transistor and a load current at the output node.

### CROSS-REFERENCE TO RELATED APPLICATIONS

This patent application claims priority under 35 USC § 119 to Indian Patent Application number 202441036797 filed on May 9, 2024, in the Indian Patent Office, the disclosure of which is incorporated by reference in its entirety herein.

### TECHNICAL FIELD

The present disclosure is generally directed to the field of linear regulators, and is more specifically directed to an on-chip Low Drop-Out (LDO) regulator.

### DISCUSSION OF RELATED ART

A low dropout (LDO) regulator is a type of electronic circuit that regulates a direct current (DC) voltage down to a constant level. They are designed to provide a stable output voltage even when the input voltage is only slightly higher than the output voltage. The LDO regulator may provide supply voltages to various components in electronic devices. The LDO regulator may have a small input to output difference (“dropout”) voltage, a small size, high efficiency, and low heat dissipation. The LDO regulator relies on a feedback loop to maintain a consistent output voltage. However, the LDO regulator requires a large off-chip output capacitor to stabilize the feedback loop and achieve a fast transient response during large load transients.

A capacitor-less LDO regulator may be easily integrated with other circuit modules because it does not require an additional large capacitor. The capacitor-less LDO regulator requires an internal compensation scheme to stabilize the feedback loop and a fast transient path to enhance both transient and alternating current (AC) stability performance.

### SUMMARY

According to an embodiment of the present disclosure, a Low Drop-Out (LDO) regulator circuit includes an Active Capacitor Frequency Compensation (ACFC) circuit and an output circuit. The ACFC circuit includes a current amplifier. The output circuit includes a pass transistor, an output node and an active discharge circuit connected to the output node. The current amplifier includes a source degeneration resistor-capacitor (RC) circuit configured to control a gain of the current amplifier. The ACFC circuit is configured to control a voltage of a gate terminal of the pass transistor. The active discharge circuit is configured to drain a current from the output node based on a voltage across a gate source junction of the pass transistor and a load current at the output node.

According to an embodiment of the present disclosure, a method of operating a Low Drop-Out (LDO) regulator circuit is provided. The LDO regulator circuit includes an Active Capacitor Frequency Compensation (ACFC) circuit and an output circuit. The method includes controlling, by a source degeneration resistor-capacitor (RC) circuit of the ACFC circuit, a gain of a current amplifier of the ACFC circuit at different frequencies for the ACFC circuit. Further, the method includes controlling, by the current amplifier, a voltage of a gate terminal of a pass transistor during fast load current transients. Furthermore, the method includes draining, by an active discharge circuit of the output circuit, a current from an output node of the output circuit based on a voltage across a gate source junction of the pass transistor and a load current at the output node.

According to an embodiment of the present disclosure, a Low Drop-Out (LDO) regulator circuit includes an error amplifier, an ACFC circuit, an output circuit, and an active discharge circuit. The ACFC circuit is connected to the error amplifier. The output circuit includes a pass transistor connected to the ACFC circuit and an output node. The active discharge circuit is configured to drain a current from the output node based on a voltage across a gate source junction of the pass transistor and a load current at the output node.

According to an embodiment of the present disclosure, a Low Drop-Out (LDO) regulator circuit includes an error amplifier, an ACFC circuit, an output circuit, a reference voltage generation circuit, a comparator, and an output current amplifier. The ACFC circuit is connected to the error amplifier. The output circuit includes a pass transistor connected to the ACFC circuit and an output node. The comparator is connected to the reference voltage generation circuit. The output current amplifier connected between the comparator and the output node.

### BRIEF DESCRIPTION OF THE DRAWINGS

FIG. 1A illustrates a circuit diagram of a capacitor-less Low-Dropout (LDO) regulator with a fast transient path, according to a comparative example.

FIG. 1B illustrates a circuit diagram of a capacitor-less Low-Dropout (LDO) regulator with a second stage pull-up and pull-down branches, according to a comparative example.

FIG. 2 illustrates a schematic diagram depicting an implementation of an Active Capacitor Frequency Compensation (ACFC) circuit in the capacitor-less LDO regulator, according to a comparative example.

FIG. 3 illustrates a graph depicting a ripple voltage in the capacitor-less LDO regulator, according to a comparative example.

FIGS. 4A and 4B illustrate circuit diagrams depicting leaker current implementations in a capacitor-less LDO regulator, according to comparative examples.

FIG. 5 illustrates a circuit diagram of an Low-Dropout (LDO) regulator circuit, according to an embodiment of the disclosure.

FIG. 6 illustrates a circuit diagram of a modified Active Capacitor Frequency Compensation (ACFC) circuit with source degeneration RC circuit, according an embodiment of the disclosure.

FIG. 7 illustrates a circuit diagram of an active discharge circuit for the LDO regulator circuit of FIG. 5, according to an embodiment of the disclosure.

FIG. 8 illustrates a method of operating the LDO regulator circuit, according to an embodiment of the disclosure.

### DETAILED DESCRIPTION

It will be understood by those skilled in the art that the following detailed description are explanatory of embodiments of the inventive concept and are not intended to be restrictive thereof.

The embodiments herein and the various features and details thereof are explained more fully with reference to the non-limiting embodiments that are illustrated in the accompanying drawings and detailed in the following description. Also, the various embodiments described herein are not necessarily mutually exclusive, as some embodiments can be combined with one or more other embodiments to form new embodiments. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, may be physically implemented by analog or digital circuits such as logic gates, integrated circuits, microprocessors, micro-controllers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the inventive concept.

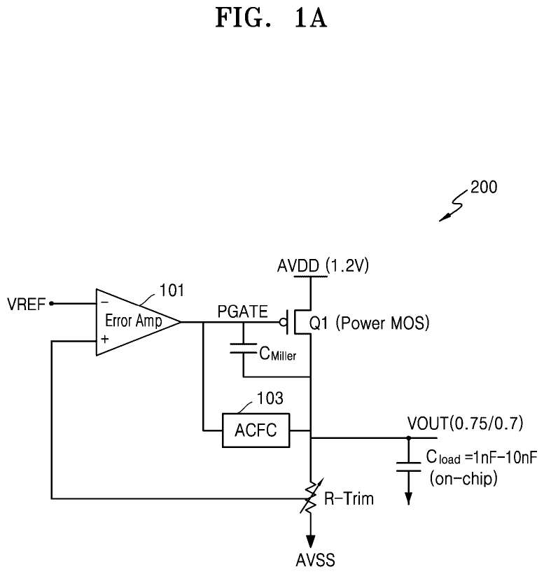

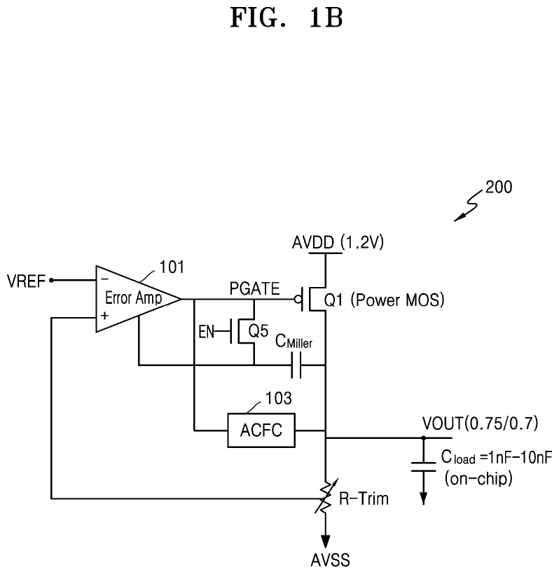

FIG. 1A illustrates a circuit diagram of a capacitor-less Low-Dropout (LDO) regulator 100 with a fast transient path. As shown in FIG. 1A, the capacitor-less Low-Dropout (LDO) regulator 100 includes an error amplifier 101, an ACFC circuit 103, a feedback loop, and an output circuit. The feedback loop feeds a fraction of an output voltage to the error amplifier 101. The output circuit includes a miller capacitor (C_{Miller}), a power metal-oxide-semiconductor (MOS) (Q1), and an output node (V_{OUT} node). The ACFC circuit 103 combined with the miller capacitor (C_{Miller}) acts as a large miller capacitor that splits dominant and non-dominant poles of the feedback loop more efficiently compared to a miller compensator. The differentiator arrangement provides a fast transient response path for transient current by charging/discharging a PGATE node during fast load transients. The power MOS (Q1) may be referred to as a pass device or a pass transistor. The error amplifier 101 may receive a reference voltage VREF. The power MOS (Q1) may receive a supply voltage AVDD. For example, the supply voltage AVDD may be 1.2 volts. Examples of the output voltage include 0.7 volts and 0.75 volts. The capacitor-less LDO regulator may additionally include a variable capacitor R-Trim receiving a ground voltage AVSS. The capacitor-less LDO regulator may be disposed on a chip (on-chip) and connected to an element of the chip having a load capacitance C_{Load} (e.g., 1 nF-10 nF).

However, the capacitor-less LDO regulator 100 with the ACFC circuit 103 suffers from a large inrush current through the power MOS (Q1) during “Supply Ramp” when EN=0 with the miller capacitor (C_{Miller}) connected between a gate and a drain of the power MOS (Q1). The capacitor-less Low-Dropout (LDO) regulator 200 in FIG. 1B with a second stage pull-up and pull-down branches separated through an MOS (Q5) may be used to address this inrush current issue. As shown in FIG. 1B, in the error amplifier 101, the second stage pull-up and pull-down branches are separated through the MOS (Q5), whose gate is controlled by EN signal, and where a top plate of the miller capacitor is indirectly connected to a gate of the power MOS (Q1) through the MOS (Q5).

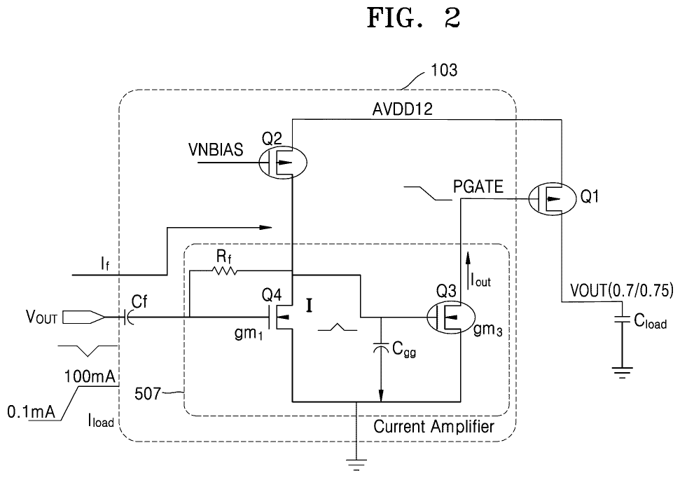

FIG. 2 illustrates a circuit diagram depicting an implementation of the ACFC circuit 103 in the capacitor-less LDO regulator 100. As shown in FIG. 2, the ACFC circuit 103 includes a current amplifier. A capacitor C_{f} acts as a differentiator, and it senses any change in voltage at the output node (V_{OUT} node). The change in output voltage induces the change in current (I_{f}) proportional to C_{f} during load transients and MOS (Q4) and resistor R_{f} acts as a trans-impedance amplifier to convert the current (I_{f}) current into voltage. The MOS (Q3) acts as a transconductance amplifier to convert voltage at the MOS (Q4) drain into a current (Iₒᵤₜ). The MOS (Q4), MOS (Q3), and resistor R_{f} combined act as a current amplifier of input current (I_{f}), thereby increasing the effective capacitance of the differentiator. The current amplifier circuit receives the current (I_{f}) as an input from the output node (V_{OUT} node) and outputs the current (Iₒᵤₜ) to a gate terminal of the power MOS (Q1) of the output circuit. The MOS (Q4) may have a transconductance value of gm₁ and the MOS (Q3) may have a transconductance value of gm₃. The ACFC circuit 103 may include a capacitor C_{gg}. The MOS (Q2) may be controlled by a bias signal VBIAS.

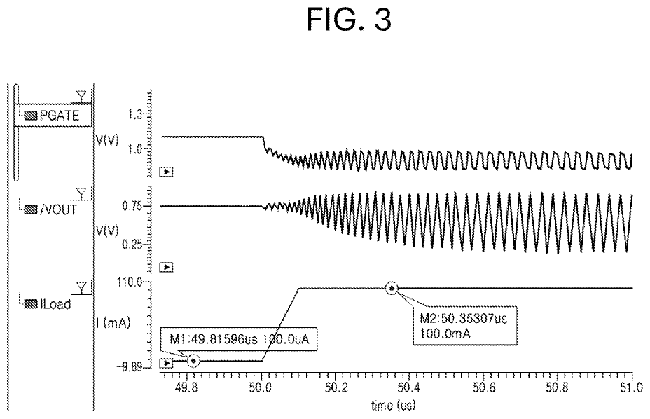

FIG. 3 illustrates a graph depicting ripple voltage at an output node VOUT with ACFC and miller configuration in the capacitor-less LDO regulators 100 and 200. As shown in FIG. 3, the ACFC circuit is combined with the miller capacitor (C_{Miller}) leading to the oscillations during the fast multifold jump in a load current I_{Load} at the capacitive C_{load} (such as a 1000× jump in current and cap=max C_{load}/10). Further, as shown in FIG. 3, an initial small ripple voltage on PGATE is amplified by a higher DC gain of the current amplifier resulting in a higher ripple voltage at the output node VOUT.

Furthermore, each LDO regulator including the capacitor-less LDO regulators 100 and 200 requires a leaker current in no-load conditions to maintain loop regulation, especially in fast process corner, high-temperature cases (e.g., 150° C.).

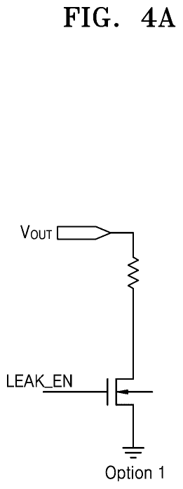

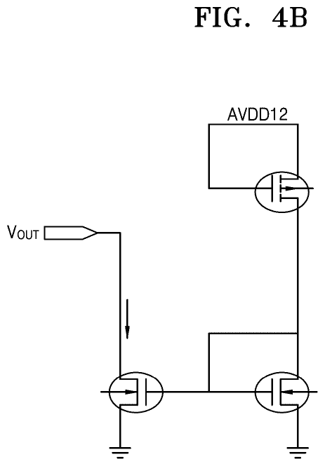

FIGS. 4A and 4B illustrate circuit diagrams depicting leaker current implementations in the capacitor-less LDO regulators 100 and 200. As shown in FIG. 4A, a leaker branch is always ON at all corners, which adds to the LDO quiescent current. Further, FIG. 4B shows a crude implementation of leaker current based on PMOS leakage. However, this leaker current implementation leaks significant current in the typical process corner which results in higher quiescent current for the capacitor-less LDO regulators 100 and 200.

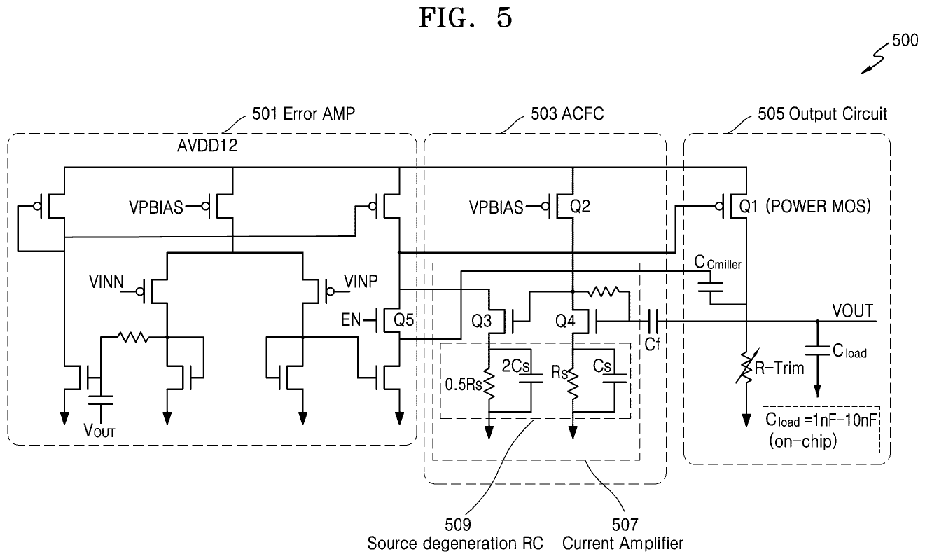

FIG. 5 illustrates a circuit diagram of a Low-Dropout (LDO) regulator circuit 500, according to an embodiment of the disclosure. When the LDO regulator circuit 500 is disposed on an integrated circuit, it may be referred to as an on-chip LDO regulator.

FIG. 5 shows a circuit-level implementation of the Low-Dropout (LDO) regulator 500 with a source degeneration ACFC. The LDO regulator 500 includes an error amplifier 501, an Active Capacitor Frequency Compensation (ACFC) circuit 503, and an output circuit 505.

The error amplifier 501 receives a feedback voltage from the output circuit 505 and provides AC current to charge/discharge a large parasitic capacitor at a gate of an output pass transistor based on load current variation at an output node VOUT of the output circuit 505. The output pass transistor may be the Q1 (POWER MOS). The error amplifier 501 may receive the feedback voltage from the output pass transistor. Further, the error amplifier 501 controls an ON resistance of the output pass transistor. The error amplifier 501 raises the ON resistance when the feedback voltage is higher than a certain voltage and lowers the ON resistance when the feedback voltage is lower than the certain voltage.

The ACFC circuit 503 includes a current amplifier 507. The current amplifier includes a source degeneration Resistor-Capacitor (RC) circuit 509. The source degeneration RC circuit 509 includes a combination of a resistor and a capacitor. The source degeneration RC circuit 509 acts as a source degeneration for the current amplifier 507 for controlling the gain of the current amplifier 507. The ACFC circuit 503 controls a voltage of a gate terminal of a power MOS (Q1) during fast load current transients. The power MOS (Q1) may also be referred to as a pass transistor.

The output circuit 505 includes the power MOS (Q1), a miller capacitor (C_{Miller}), and the output node VOUT. A value of the load capacitor C_{load} at the output node VOUT may range from 1 nF to 10 nF. The differentiator arrangement of the LDO regulator 500 provides a fast transient response path for transient current by charging/discharging a PGATE node of the power MOS (Q1) during load transients.

The error amplifier 501 may include various transistors such as some receiving a supply voltage AVDD12, one being controlled by a bias signal VPBIAS, one being controlled by an input voltage VINN, one being controlled by an inverted input signal VINP, and a transistor Q5 being controlled by an enable signal EN. The ACFC circuit 503 may include a transistor Q2 controlled by the bias signal VPBIAS and a capacitor Cf. The current amplifier 507 may include a resistor Rf and transistors Q3 and Q4. The source degeneration Resistor-Capacitor (RC) circuit 509 may include a first resistor (0.5 Rs) connected in parallel with a first capacitor (2Cs) and a second resistor (Rs) connected in parallel with a second capacitor (Cs), where a resistance of the first resistor is half the resistance of the second resistor and a capacitance of first capacitor is twice the capacitance of the second capacitor.

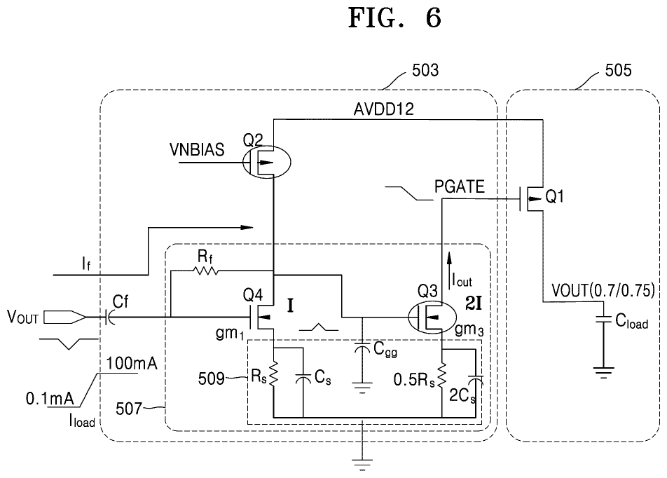

FIG. 6 illustrates a circuit diagram of a modified Active Capacitor Frequency Compensation (ACFC) circuit 503 with source degeneration RC circuit 509, according to an embodiment of the disclosure.

As shown in FIG. 6, the Low-Dropout (LDO) regulator 500 uses the modified ACFC circuit 503 in which an ACFC circuit is modified to include the source degeneration RC circuit 509 in the current amplifier 507 circuit. The source degeneration RC circuit 509 includes the combination of the resistor and the capacitor. For example, the source degeneration RC circuit 509 may include a first Parallel RC combination with a resistor value Rs and a capacitor value Cs. Further, the source degeneration RC circuit 509 may also include a second Parallel RC combination with a resistor value of 0.5 Rs and a capacitor value of 2 Cs.

Further, MOS (Q3) and MOS (Q4) of the current amplifier 507 act as a transconductance amplifier with a transconductance value of gm₃, and gm₁, respectively. The transconductance values gm₁ and gm₃ help to boost the effective capacitance of ACFC circuit 503 so that the capacitance value of the capacitor (C_{f}) is reduced and thus an area of the circuit is reduced. Output current (2I) from the second Parallel RC combination increases the value of the transconductance value gm₃.

Further, the source degeneration RC circuit 509 acts as the source degeneration for the current amplifier 507 by controlling the gain of the current amplifier 507 at different frequencies. The source degeneration RC circuit 509 reduces the gain at low frequencies and therefore reduces or prevents oscillations at the output node VOUT during a multifold jump in load current. The source degeneration RC circuit 509 has a zero frequency such that the gain of the current amplifier 507 is low at low frequency and the current amplifier 507 has full gain without any degeneration at a higher frequency (>10× LDO closed loop bandwidth) for the ACFC circuit 503.

Further, the ACFC circuit 503 acts as a large miller capacitor of C_{f}*current amplifier gain, in a differentiator configuration. Since the amount of undershoot at the output mode VOUT is inversely proportional to a differentiator capacitance value, the increased gain of the current amplifier 507 at a higher frequency reduces the undershoot at the output node VOUT during the fast load current transients.

In an embodiment, a source degeneration zero frequency is chosen well outside a loop bandwidth of a loop of the LDO regulator 500 so that the zero frequency does not disturb loop dynamics. Also, the gain of the current amplifier 507 may be low for frequencies lower than the loop bandwidth of the LDO regulator 500. For example, the gain of the current amplifier 507 may be less than a threshold value for frequencies lower than the loop bandwidth of the LDO regulator 500 and higher than the threshold value for frequencies greater than or equal to the loop bandwidth of the LDO regulator 500.

However, during low output current conditions in a prior LDO regulator, a voltage at the PGATE node of the power MOS (Q1) is close to the input supply voltage because of the large drive strength of the power MOS (Q1) to support full load current at a slow process corner. The above condition makes the drive impedance of the load device in the error amplifier very high, and the loop may be no longer controlled by feedback.

Therefore, to maintain loop regulation in a no load condition, an active discharge circuit is introduced to sink current from a supply voltage through the power MOS (Q1), which may be a pass gate device.

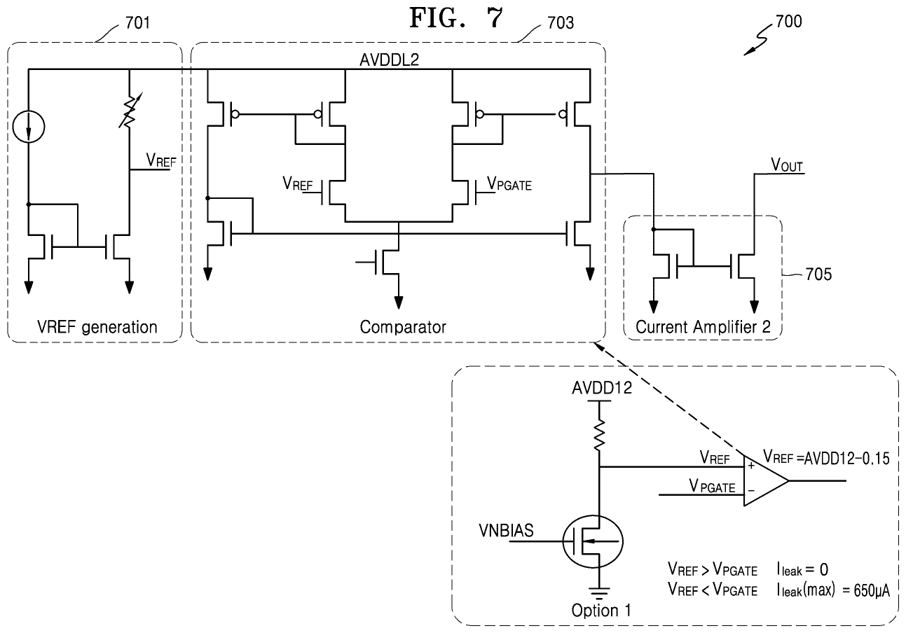

FIG. 7 illustrates a circuit diagram of a discharge circuit 700 for the LDO regulator circuit 500 of FIG. 5, according to an embodiment of the disclosure. The discharge circuit 700 includes a reference voltage generation circuit 701, a comparator 703, and an output current amplifier 705.

As shown in FIG. 7, the active discharge circuit 700 is connected to the output node VOUT. The active discharge circuit 700 drains a current from the output node VOUT based on a voltage across a gate source junction of the power MOS (Q1) (pass transistor) and a specific load current required at the output node VOUT. The active discharge circuit 700 may act as a Process, supply Voltage and Temperature (PVT) dependent adaptive current sink. The active discharge circuit 700 may be included in or connected to the output circuit 505.

The reference voltage generation circuit 701 generates a reference voltage V_{REF}. The reference voltage V_{REF} may be generated by pumping a current proportional to a ground referred reference voltage into a resistor ladder. For example, reference voltage V_{REF} may be generated by pumping a current proportional to a ground voltage into a resistor ladder. The reference voltage generation circuit 701 may include transistors, a current source, and a variable resistor.

The comparator 703 compares a voltage across a gate source junction of the power MOS (Q1) (e.g., V_{PGATE}) with a supply referred reference voltage V_{REF} to generate a comparison voltage. Further, the comparator 703 may pump an error current into the output current amplifier 705 connected to the output node VOUT of the LDO regulator 500 based on the comparison voltage.

In an embodiment, the active discharge circuit 700 supplies a sinking current from a drain terminal of the power MOS (Q1) (pass transistor) when the voltage across the gate source junction of the power MOS (Q1) (pass transistor) is less than the supply referred reference voltage. In a non-limiting example, a maximum value of the sinking current may be 650 μA, while a typical process corner sinking current is a few nA.

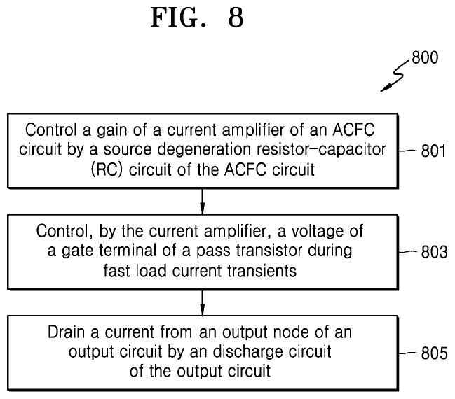

FIG. 8 illustrates a method 800 of operating the LDO regulator 500 circuit, according to an embodiment of the disclosure. The method 800 includes a series of operation steps 801 through 805 performed by one or more circuits of the LDO regulator 500.

At step 801, the source degeneration RC circuit 509 of the ACFC circuit 503 controls the gain of the current amplifier 507 of the ACFC circuit 503 at different frequencies for the ACFC circuit 503. The flow of the first method 800 now proceeds to step 803.

At step 803, the current amplifier 507 in the ACFC circuit 503 controls the voltage of the gate terminal of the power MOS (Q1) during the fast load current transients. The current amplifier 507 controls the voltage of the gate terminal of the power MOS (Q1) in response to the control of the gain of the current amplifier 507 by the source degeneration RC circuit 509. The flow of the first method 800 now proceeds to step 805.

At step 805, the discharge circuit 700 drains the current from the output node of the output circuit 505 based on the voltage across the gate source junction of the power MOS (Q1) and the specific load current required at the output node.

The source degeneration RC circuit in the current amplifier of the LDO regulator according to an embodiment reduces a ripple voltage at the output VOUT node during fast current load transients. Further, the LDO regulator with the RC source degenerated ACFC circuit increases the transient response (e.g., reduces overshoot/undershoot) without impacting the loop stability and/or without inducing oscillations during multifold jump in load currents of the LDO regulator.

Furthermore, the proposed active discharge circuit helps to maintain loop regulation (e.g., minimizes a system offset) during light load conditions and sinks current only when the voltage at the PGATE node of the power MOS (Q1) referred to supply is less than the supply referred reference voltage. Furthermore, the proposed active discharge circuit sinks the current from the supply especially in the fast process corner, at a higher temperature (e.g., 150° C.) and at no load whereas a passive discharge circuit always sinks the current irrespective of load condition and process corner condition.

The various actions, acts, blocks, steps, or the like in the flow diagrams may be performed in the order presented, in a different order, or simultaneously. Further, in some embodiments, some of the actions, acts, blocks, steps, or the like may be omitted, added, modified, skipped, or the like without departing from the scope of the invention.

As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

While various embodiments herein have been described, those skilled in the art will recognize that the embodiments herein can be practiced with modification within the scope of the embodiments as described herein.

What is claimed is:

1. A Low Drop-Out (LDO) regulator circuit, comprising:
an Active Capacitor Frequency Compensation (ACFC) circuit comprising a current amplifier; and
an output circuit comprising a pass transistor, an output node and an active discharge circuit connected to the output node,
wherein the current amplifier comprises a source degeneration resistor-capacitor (RC) circuit configured to control a gain of the current amplifier,
wherein the ACFC circuit is configured to control a voltage of a gate terminal of the pass transistor,
wherein the active discharge circuit is configured to drain a current from the output node based on a voltage across a gate source junction of the pass transistor and a load current at the output node.

2. The LDO regulator circuit of claim 1, wherein the active discharge circuit is further configured to:
compare the voltage across the gate source junction of the pass transistor with a reference voltage to generate a comparison voltage, wherein the reference voltage is generated by pumping a current proportional to a ground voltage into a resistor ladder; and
pump an error current into an output node current amplifier connected to the output node of the LDO regulator circuit based on the comparison voltage.

3. The LDO regulator circuit of claim 2, wherein the active discharge circuit is further configured to supply a sinking current from a drain terminal of the pass transistor when the voltage across the gate source junction of the pass transistor is less than the reference voltage.

4. The LDO regulator circuit of claim 1,
wherein the source degeneration RC circuit includes a combination of a resistor and a capacitor, and
wherein the source degeneration RC circuit is configured to act as a source degeneration for the current amplifier for controlling the gain at different frequencies.

5. The LDO regulator circuit of claim 4, wherein a zero frequency of the source degeneration RC circuit is outside a loop bandwidth of a feedback loop of the LDO regulator circuit.

6. The LDO regulator circuit of claim 1, wherein a gain of the current amplifier is less than a threshold value for frequencies lower than a loop bandwidth of the LDO regulator circuit.

7. An integrated circuit comprising the LDO regulator circuit of claim 1.

8. A Low Drop-Out (LDO) regulator circuit, comprising:
an error amplifier;
an Active Capacitor Frequency Compensation (ACFC) circuit connected to the error amplifier;
an output circuit including a pass transistor connected to the ACFC circuit and an output node; and
an active discharge circuit configured to drain a current from the output node based on a voltage across a gate source junction of the pass transistor and a load current at the output node.

9. The LDO regulator circuit of claim 8, wherein the active discharge circuit comprises:
a reference voltage generation circuit;
a comparator connected to the reference voltage generation circuit; and
an output current amplifier connected between the comparator and the output node.

10. The LDO regulator circuit of claim 9, wherein the comparator compares a voltage across a gate source junction of the pass transistor with a reference voltage generated by the reference voltage generation circuit to generate a comparison voltage and pumps an error current into the output current amplifier based on the comparison voltage.

11. The LDO regulator circuit of claim 9, wherein the error amplifier receives a feedback voltage from the output circuit.

12. The LDO regulator circuit of claim 11, wherein the error amplifier raises an ON resistance of pass transistor when the feedback voltage is higher than a certain voltage and lowers the ON resistance when the feedback voltage is lower than the certain voltage.

13. The LDO regulator circuit of claim 9, wherein the ACFC circuit comprises a current amplifier including a source degeneration Resistor-Capacitor circuit.

14. The LDO regulator circuit of claim 13, wherein the source degeneration Resistor-Capacitor circuit comprises:
a first resistor connected in parallel with a first capacitor; and
a second resistor connected in parallel with a second capacitor,
where a resistance of the first resistor is half the resistance of the second resistor and a capacitance of first capacitor is twice the capacitance of the second capacitor.

15. The LDO regulator circuit of claim 9, wherein the output circuit further comprises a Miller capacitor.

16. The LDO regulator circuit of claim 9, wherein the active discharge circuit is further configured to supply a sinking current from a drain terminal of the pass transistor when the voltage across the gate source junction of the pass transistor is less than a reference voltage generated by the reference voltage generation circuit.

17. A Low Drop-Out (LDO) regulator circuit, comprising:
an error amplifier;
an Active Capacitor Frequency Compensation (ACFC) circuit connected to the error amplifier;
an output circuit including a pass transistor connected to the ACFC circuit and an output node;
a reference voltage generation circuit;
a comparator connected to the reference voltage generation circuit; and
an output current amplifier connected between the comparator and the output node.

18. The Low Drop-Out (LDO) regulator circuit of claim 17, wherein the comparator compares a voltage across a gate source junction of the pass transistor with a reference voltage generated by the reference voltage generation circuit to generate a comparison voltage and pumps an error current into the output current amplifier based on the comparison voltage.

19. The LDO regulator circuit of claim 18, wherein the ACFC circuit comprises a current amplifier including a source degeneration Resistor-Capacitor circuit.

20. The LDO regulator circuit of claim 19, wherein the source degeneration Resistor-Capacitor circuit comprises:
a first resistor connected in parallel with a first capacitor; and
a second resistor connected in parallel with a second capacitor,
where a resistance of the first resistor is half the resistance of the second resistor and a capacitance of first capacitor is twice the capacitance of the second capacitor.
